(19) United States
(12) Patent Application Publication
(10) Pub. No.: US 2025/0158331 A1
(43) Pub. Date: May 15, 2025

(54) ATTACHMENT STRUCTURE OF CONNECTOR

(71) Applicant: SMK Corporation, Tokyo (JP)

(72) Inventors: Ryutaro TAKANO, Tokyo (JP); Tadahito SASAKI, Tokyo (JP)

(21) Appl. No.: 18/631,034

(22) Filed: Apr. 9, 2024

(30) Foreign Application Priority Data
Nov. 14, 2023 (JP) 2023-193671

(51) Int. Cl. H01R 13/639; H01R 24/40; H01R 103/00

(52) U.S. Cl. CPC H01R 13/639; H01R 24/40; H01R 2103/00

(57) ABSTRACT

In an attachment structure of a connector, a key groove extending in an axial direction of a cylinder, external insertion grooves formed at an inner circumferential portion on both sides of the key groove with the key groove interposed therebetween, and a insertion inlet which communicates with the external insertion grooves are formed in an external fitting body. a pressing projection provided to be protruded on an outer circumferential surface, and an internal insertion groove formed at an outer circumferential portion on both sides of the projection with the projection interposed therebetween are formed in an internal fitting body. A retainer is inserted from the insertion inlet, insertion pieces thereof are inserted across the internal insertion groove and the external insertion grooves, and a retainer base portion is overlapped between edge portions on both sides of the projection and on both sides of the key groove.

### CROSS-REFERENCE TO RELATED APPLICATIONS

This application claims the priority benefit under 35 U.S.C. § 119 of Japanese Patent Application No. 2023-193671 filed on Nov. 14, 2023, which is hereby incorporated in its entirety by reference.

### FIELD

The present invention relates to an attachment structure of a connector that allows a module such as an imaging device to be firmly attached to a coaxial cable or the like via a connector.

### BACKGROUND

A module such as a camera module for an in-vehicle camera is connected to a coaxial cable by using a connector for a module that includes a socket and a plug. The socket is housed in an internal fitting body that is cylindrical in shape and provided to protrude integrally at one surface of a case that houses the module. The plug (hereinbelow referred to as a jack) is housed in an external fitting body attached to a tip end portion of the coaxial cable. By fitting the internal and external fitting bodies to each other to connect the plug to the socket, the module is connected to the coaxial cable (for example, refer to Patent Literature 1).

In such a connector for a module, the plug and the socket may be detached due to vibration or the like. Therefore, it is desirable to keep a state in which the plug and the socket are firmly connected.

On the other hand, as a structure that firmly fixes a connector to a device building frame (case) (the structure is hereinbelow referred to as an attachment structure of a connector), a structure that prevents detachment of a plug by fixation of the plug to the device building frame using a fixing tool called a retainer is known (for example, refer to Patent Literature 2).

In the attachment structure of a connector, internal retainer insertion grooves are provided on both sides of a resin-made housing (hereinbelow referred to as an internal fitting body) that houses a plug with a central axis of the housing interposed therebetween. Furthermore, external retainer insertion grooves are provided at internal portions of a part of a device building frame in which the internal fitting body is inserted (the part is hereinbelow referred to as an external fitting body). The internal retainer insertion grooves and the external retainer insertion grooves are opposed to each other, and insertion pieces of a retainer are inserted into the insertion spaces across the internal and external retainer insertion grooves. When a force is applied in a direction of pulling the plug out of the device building frame, an opposing force due to shear strength of the retainer (insertion piece) fixes the connector to the device building frame and prevents detachment of the connector from the device building frame.

### BRIEF SUMMARY OF THE INVENTION

However, in the technique described above, in a case where the inserted insertion piece of the retainer is closer to either the internal or external retainer insertion groove than the other because of the insertion position of the retainer being shallow or another reason, or in a case where there is a possibility that the insertion piece moves between the internal and external retainer insertion grooves, the area of overlap between the insertion piece and either the internal or external retainer insertion groove may be reduced. As a result, the force due to shear strength of the retainer (insertion piece) may not function properly, and a stable fixing state may not be obtained.

The present invention has been devised in view of the problems in association with the art, and an object thereof is to provide an attachment structure of a connector for fixing the connector to a case or the like in a stable manner that prevents detachment of the connector from the case or the like.

### SUMMARY

To solve the conventional problems described above, an attachment structure of a connector according to a first aspect of the present invention is provided. In the attachment structure of a connector, the connector includes an internal fitting body and an external fitting body that are fitted to each other, so that a plug in either the internal fitting body or the external fitting body and a socket in the other are connected to each other in a manner that prevents detachment of the fixed connector in a fitting direction. The external fitting body includes a key groove which extends in an axial direction of a cylinder on an inner circumferential surface, external retainer insertion grooves which are formed at an inner circumferential portion on both sides of the key groove with the key groove interposed therebetween, and a retainer insertion inlet which communicates with the external retainer insertion grooves. The internal fitting body includes a pressing projection which is provided to be protruded on an outer circumferential surface and is inserted into the key groove, and an internal retainer insertion groove which is formed at an outer circumferential portion on both sides of the pressing projection with the pressing projection interposed therebetween. A retainer in which paired insertion pieces are supported on both ends of a retainer base portion is inserted from the retainer insertion inlet, the insertion pieces are inserted across the internal retainer insertion groove and the external retainer insertion grooves, and the retainer base portion is overlapped between edge portions on both sides of the pressing projection and on both sides of the key groove.

In the attachment structure of a connector according to the first aspect, a second aspect of the present invention is configured such that the pressing projection extends to an upper end of the internal fitting body.

In the attachment structure of a connector according to the first or second aspect, a third aspect of the present invention is configured such that the internal fitting body is provided to be protruded integrally with one surface of a box-shaped building frame.

Since the attachment structure of a connector of the present invention is configured according to the first aspect, the retainer base portion is always overlapped between the edge portions on both sides of the pressing projection and on both sides of the key groove. Accordingly, even in a case where the retainer is at a shallow insertion position, the retainer always functions as a shear resisting key, and a stable fixing state can be maintained.

Also, since the attachment structure of a connector of the present invention is configured according to the second aspect, guiding at the time of connector connection is facilitated.

Furthermore, since the attachment structure of a connector of the present invention is configured according to the third aspect, a stable fixing state can be maintained even in a case where a jack is connected outside of the case.

### BRIEF DESCRIPTION OF DRAWINGS

These and other characteristics, features, and advantages of the aspect(s) of the present invention will become clear from the following description with reference to the accompanying drawings, wherein:

FIG. 1 is a perspective view illustrating a module and a jack connected using an attachment structure of a connector according to an embodiment of the present invention;

FIG. 2 is an exploded perspective view of the connector of FIG. 1;

FIG. 3 is a vertical cross-sectional view of the connector of FIG. 1;

FIG. 4A is a plan view illustrating the jack in FIG. 1;

FIG. 4B is a bottom view illustrating the jack in FIG. 1;

FIG. 4C is a front view illustrating the jack in FIG. 1;

FIG. 5A is an enlarged vertical cross-sectional view of the jack in FIGS. 4A-4C;

FIG. 5B is a cross-sectional view taken along line A-A in FIG. 5A;

FIG. 6A is a plan view illustrating a rear case in FIG. 1;

FIG. 6B is a front view illustrating a rear case in FIG. 1;

FIG. 6C is a side view illustrating a rear case in FIG. 1;

FIG. 7 is an enlarged vertical cross-sectional view of FIG. 6C;

FIG. 8A is an enlarged cross-sectional view taken along line B-B illustrating an internal fitting body part in FIG. 7;

FIG. 8B is an enlarged cross-sectional view taken along line C-C in FIG. 7;

FIG. 8C is an enlarged cross-sectional view taken along line D-D in FIG. 7;

FIG. 9 is a perspective view illustrating a retainer;

FIG. 10 is a horizontal cross-sectional view illustrating a state in which internal and external fitting bodies are fitted, and the retainer has been inserted at a normal position, in the attachment structure of a connector in FIG. 1;

FIG. 11 is a horizontal cross-sectional view illustrating a state in which the internal and external fitting bodies are fitted, and the retainer has been inserted at a shallow position, in the attachment structure of a connector in FIG. 1; and

FIG. 12 is a partially enlarged cross-sectional view of the state in FIG. 11.

### DESCRIPTION OF INVENTION

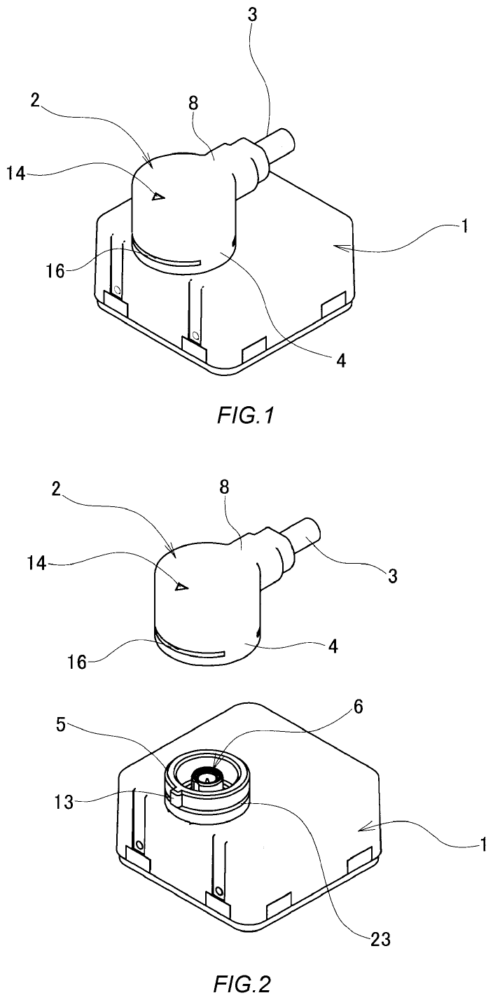

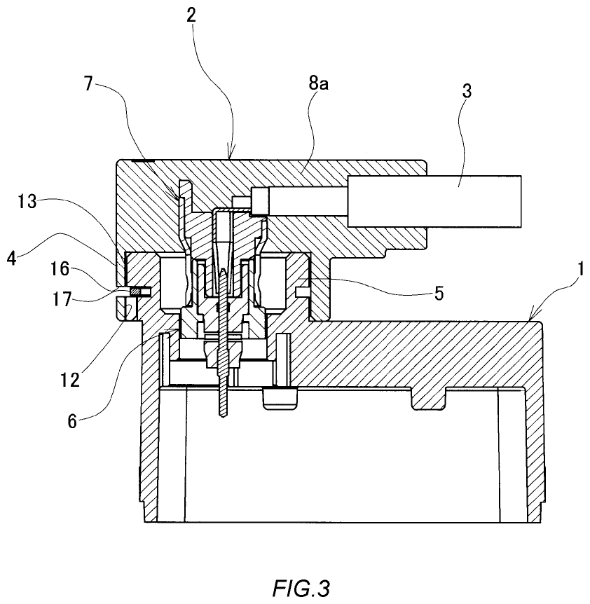

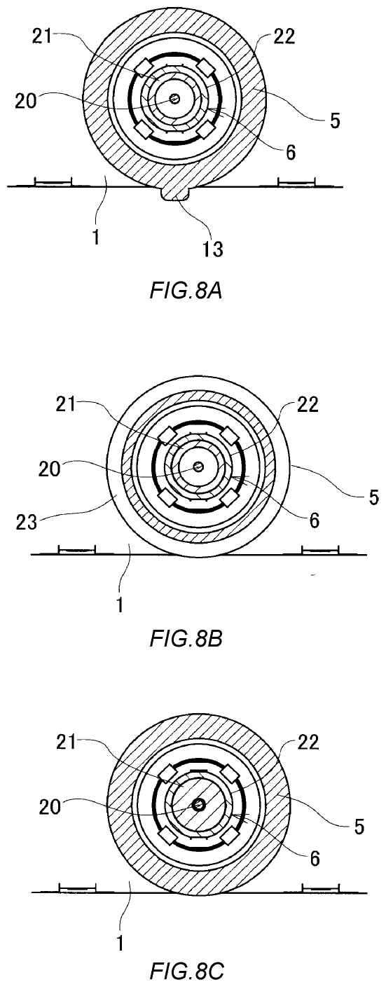

A description will now be made below with regards to an attachment structure of a connector of the present invention with reference to the FIGS. 1 to 12 in accordance with an embodiment.

The present embodiment will be described, using a case of connecting a module such as a camera module to a jack attached to the tip end of a coaxial cable as an example, as illustrated in FIGS. 1 to 3. In the figures, a rear case for a module is labeled with reference sign 1, and a jack attached to the tip end of a coaxial cable 3 is labeled with reference sign 2.

The attachment structure of a connector includes an external fitting body 4 provided on the side provided with the jack 2 and an internal fitting body 5 provided on the side provided with the rear case 1. The external fitting body 4 and the internal fitting body 5 are fitted to each other to cause a plug 6 arranged in the internal fitting body 5 and a socket 7 arranged in the external fitting body 4 to be connected to each other, so that the external fitting body 4 and the internal fitting body 5 are attached to each other, without risk of detachment, by a retainer 17.

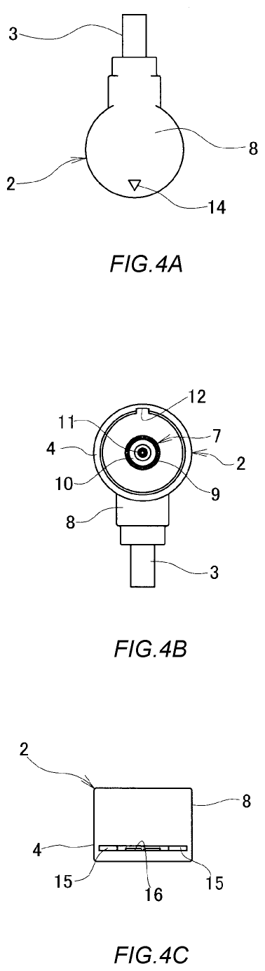

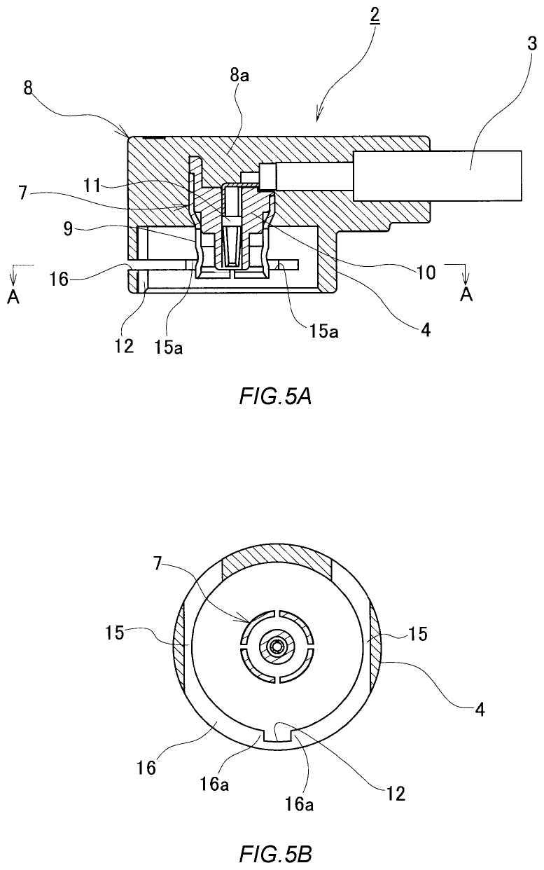

As illustrated in FIGS. 4A to 5B, the jack 2 includes the socket 7 attached to the tip end of the coaxial cable 3 and an external cover 8, which holds the socket 7 and is made of an insulating resin. The socket 7 attached to the tip end of the coaxial cable 3 is integrated with the external cover 8 by molding, so that the tip end portion of the socket 7 is arranged in a protruded state in the cylindrical external fitting body 4, which is provided to be protruded on one surface of the external cover 8.

The aspect of the socket 7 is not limited in particular. For example, as illustrated in FIG. 5A, the socket 7 includes a shell 9 made of a conductive metal and having a cylindrical shape, an insulator 10 made of an insulating resin and housed in the shell 9, and a central contact 11 held in the insulator 10 and coaxially arranged inside the shell 9. The socket 7 is held in a state where the central conductor of the coaxial cable 3 is connected to the central contact 11 and where the external conductor thereof is connected to the shell 9.

The external cover 8 includes a cover main body portion 8a in which the socket 7 on the base end side and the tip end of the coaxial cable 3 connected to the socket 7 are provided to be buried and the cylindrical external fitting body 4 provided to be protruded integrally with the lower surface of the cover main body portion 8a. The socket 7 on the tip end side is protruded at the central portion of the external fitting body 4.

The external fitting body 4 includes a key groove 12 that is opened in the inward direction and in the lower surface direction (end surface on the counterpart side) at a predetermined position in the inner circumferential surface portion, and that extends in the axial direction of the cylinder. A pressing projection 13 provided to be protruded on the outer circumferential surface of the internal fitting body 5 and also serving as a guide key is inserted in the key groove 12. As a result, the external fitting body 4 and the internal fitting body 5 are positioned to each other in the circumferential direction. Note that a triangular mark 14 formed on the upper surface of the external cover 8 is a marker indicating the position of the key groove 12.

Also, the external fitting body 4 includes external retainer insertion grooves 15 and 15 formed at the inner circumferential portion on both sides of the key groove 12 with the key groove 12 interposed therebetween and a retainer insertion inlet 16 opened in the outer circumferential surface of the external fitting body 4. The retainer insertion inlet 16 communicates with the external retainer insertion grooves 15 and 15, and has a laterally-facing slit shape. The retainer 17 can be inserted from the retainer insertion inlet 16.

The external retainer insertion grooves 15 and 15 are formed in a groove shape so that flat upper and lower pressing surfaces 15a and 15a, communicating with the retainer insertion inlet 16, are opposed and spaced in the up-down direction. This configuration allows the retainer 17 to be inserted between the upper and lower pressing surfaces 15a and 15a.

The retainer insertion inlet 16 is formed to have a shape that is laterally-facing slit divided by the key groove 12 in the extending direction. The retainer insertion inlet 16 is provided with abutting portions 16a and 16a at portions of the thick part of the external fitting body 4, which are the side edge portions with the key groove 12 interposed therebetween, in the up-down direction at the upper and lower opposed inside surface portions.

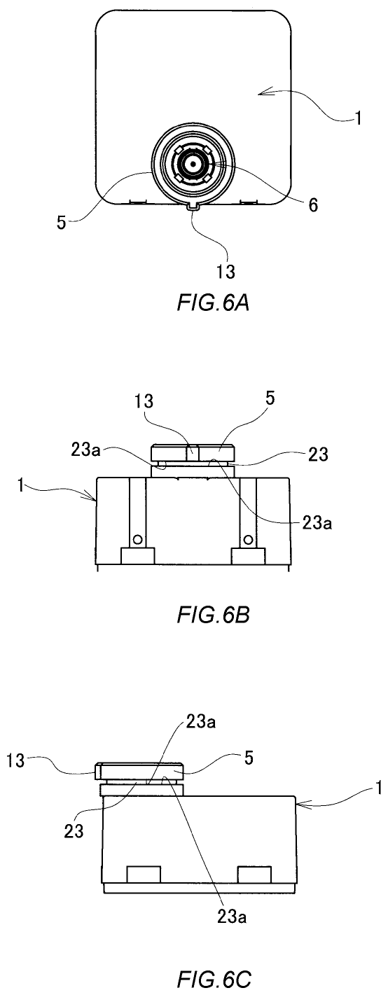

As illustrated in FIGS. 6A to 8C, in the rear case 1, the cylindrical internal fitting body 5 is provided to be protruded integrally with the upper surface portion of a box-shaped building frame 1a, and the plug 6 is housed in a state where the tip end portion thereof is protruded in the internal fitting body 5.

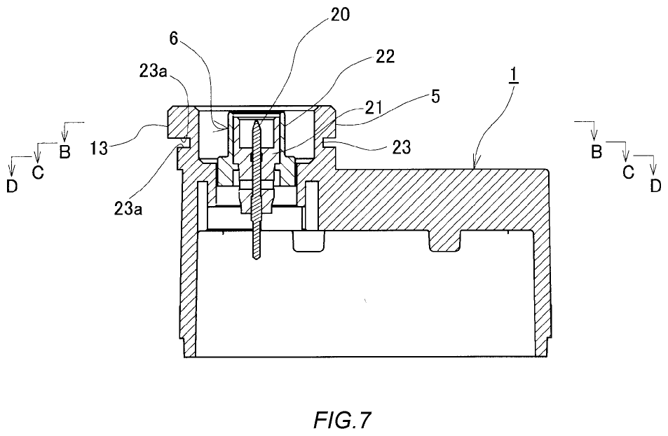

The plug 6 is matched to the socket 7 to be connected. The plug 6 includes a pin-like central contact 20 made of a conductive metal material, an insulator 21 holding the central contact 20 and made of an insulating resin, and a cylindrical shell 22 housing the insulator 21 holding the central contact 20 and made of a conductive metal material as illustrated in FIG. 7. As the internal fitting body 5 and the external fitting body 4 are fitted to each other, the shell 9 of the socket 7 is fitted to the outside of the shell 22 of the plug 6, and the pin-like central contact 20 is inserted into the central contact 11 of the socket 7, to establish connection.

The internal fitting body 5 has a cylindrical shape having approximately the same outside diameter as the inside diameter of the external fitting body 4. The internal fitting body 5 includes the pressing projection 13 provided to be protruded on the outer circumferential surface and an internal retainer insertion groove 23 formed at the outer circumferential portion on both sides of the pressing projection 13 with the pressing projection 13 interposed therebetween. The internal fitting body 5 is fitted inside the external fitting body 4 while the pressing projection 13 is inserted into the key groove 12 of the external fitting body 4.

The pressing projection 13 has a rectangular protruded line form. The lower end of the pressing projection 13 is arranged at a predetermined height position, that is, at the same height as the upper edge position of the retainer insertion inlet 16 when the internal and external fitting bodies 5 and 4 are fitted, and the upper end thereof extends to the upper end of the internal fitting body 5. The pressing projection 13 is inserted into the key groove 12 of the external fitting body 4 to function as a guide key. Note that the upper end of the pressing projection 13 does not necessarily have to extend to the upper end of the internal fitting body 5.

The internal retainer insertion groove 23 is arranged on the lower side of the pressing projection 13, that is, on the case building frame side, so that the lower end of the pressing projection 13 and the inner upper surface of the internal retainer insertion groove 23 are coplanar. The internal retainer insertion groove 23 extends over the entire inner circumferential surface of the internal fitting body 5 with a predetermined depth, and allows the retainer 17 to be inserted to both side thereof with the pressing projection 13 interposed therebetween.

The internal retainer insertion groove 23 is provided with pressing surfaces 23a and 23a opposed to each other in the up-down direction (axial direction). The distance between the pressing surfaces 23a and 23a is the same as the distance between the upper and lower pressing surfaces 15a and 15a of the external retainer insertion grooves 15 and 15.

Also, the internal retainer insertion groove 23 is arranged so as to have the same height as those of the external retainer insertion grooves 15 and 15 and the retainer insertion inlet 16 at the position at which the internal and external fitting bodies 5 and 4 are fitted to each other and the upper surface of the internal fitting body 5 abuts on the inner upper surface of the external fitting body 4 (the inner upper surface of the external fitting body 4 is the lower surface of the cover main body portion 8a). The internal retainer insertion groove 23 and the external retainer insertion grooves 15 and 15 are adjacent to each other to form one groove communicating with the retainer insertion inlet 16, and the retainer 17 can be inserted between the upper and lower pressing surfaces.

Meanwhile, in the present embodiment, although an example in which the internal retainer insertion groove 23 extends over the entire inner circumferential surface of the internal fitting body 5 has been described, a pair of internal retainer insertion grooves 23 and 23 formed to have an arc groove shape may be provided symmetrically with the pressing projection 13 interposed therebetween.

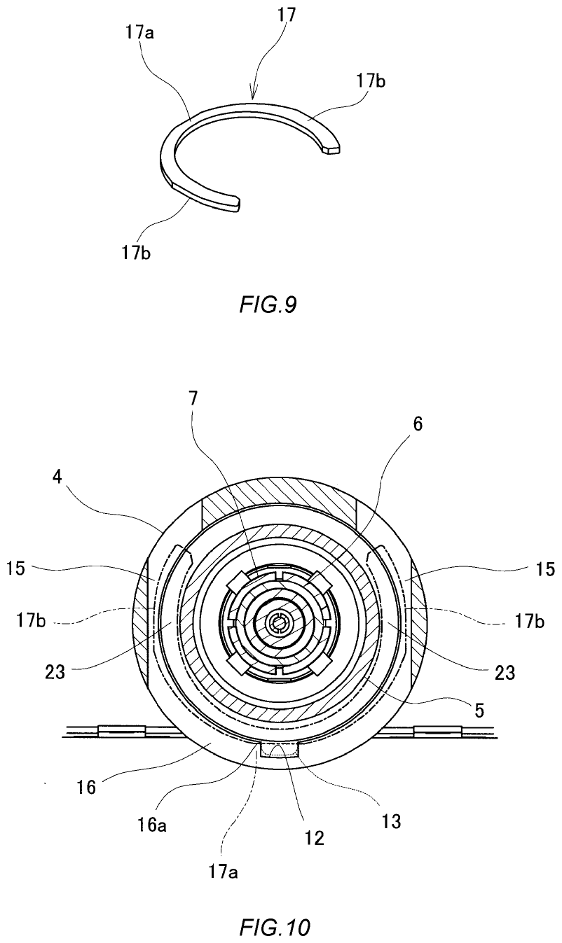

As illustrated in FIG. 9, the retainer 17 is formed by punching an elastic metal plate material to have a horseshoe shape in a plan view in which paired insertion pieces 17b and 17b are supported on both ends of a retainer base portion 17a.

Each of the insertion pieces 17b and 17b has an arc shape, having a larger width in the radial direction than that of the internal retainer insertion groove 23 and a smaller width than that of the groove formed by the external retainer insertion grooves 15 and 15. The insertion pieces 17b and 17b are inserted from the retainer insertion inlet 16 across the internal retainer insertion groove 23 and the external retainer insertion grooves 15 and 15.

The retainer base portion 17a has a smaller width in the radial direction than that of each of the insertion pieces 17b and 17b. Thus, the insertion pieces 17b and 17b can flexibly be broadened in directions away from each other so as to be fitted to the internal retainer insertion groove 23 of the internal fitting body 5.

In the attachment structure of a connector configured as above, when the internal and external fitting bodies 5 and 4 are fitted to each other, and the retainer 17 is then inserted from the retainer insertion inlet 16, in a normal case, as illustrated in FIG. 10, the insertion pieces 17b and 17b of the retainer 17 are inserted across the internal retainer insertion groove 23 and the external retainer insertion grooves 15 and 15. And also, the retainer base portion 17a is in a state of being overlapped between the edge portions on both sides of the pressing projection 13 and on both sides of the key groove 12. Thus, the retainer 17 functions as a shear resisting key, thereby preventing detachment of the internal and external fitting bodies 5 and 4 while they are fitted to each other, so that the plug 6 and the socket 7 are kept in a connected state.

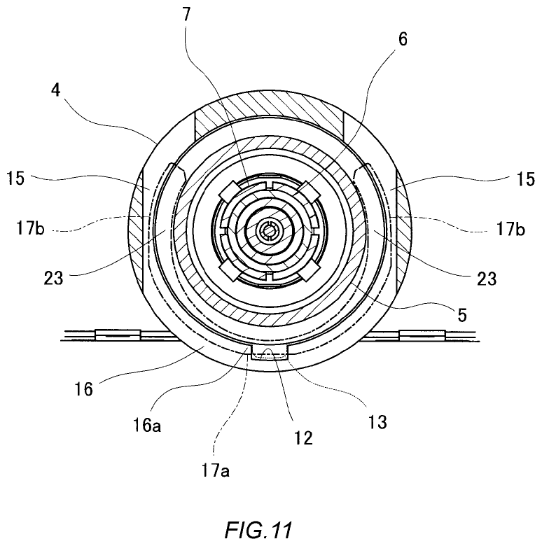

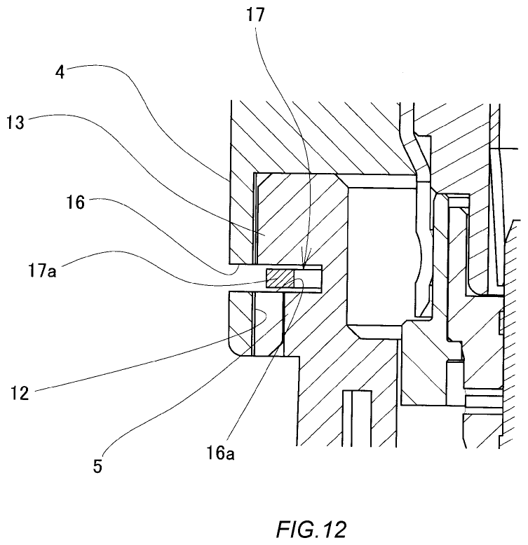

On the other hand, even in a case where the retainer 17 is at a shallow insertion position due to insufficient insertion of the retainer 17, vibration, or the like, as illustrated in FIGS. 11 and 12, the retainer base portion 17a is always kept in a state of being overlapped between the edge portions (abutting portions) 16a and 16a on both sides of the pressing projection 13 and on both sides of the key groove 12. As a result, the retainer 17 functions as a shear resisting key, thereby preventing detachment of the internal and external fitting bodies 5 and 4 while they are fitted to each other, so that the plug 6 and the socket 7 are kept in a connected state.

Note that, in the embodiment described above, although a case where the socket 7 is arranged on the side provided with the jack 2 (external fitting body 4) and the plug 6 is arranged on the side provided with the case (internal fitting body 5) has been described, the plug 6 may be arranged on the side provided with the jack 2, and the socket 7 may be arranged on the side provided with the case.

Also, in the embodiment described above, although a case where a coaxial connector is used as a connector has been described, the type of the connector is not limited to this and may be a multipole connector.

Furthermore, in the embodiment described above, although a case where the attachment structure of a connector is applied to the connection between the jack 2 and the rear case 1 has been described, the attachment structure of a connector can not only be applied as in the present embodiment but can also be applied to any connector that establishes connection by fitting the external fitting body 4 to the internal fitting body 5.

### REFERENCES SIGNS LIST

1 rear case
2 jack
3 coaxial cable
4 external fitting body
5 internal fitting body
6 plug
7 socket
8 external cover
9 shell
10 insulator
11 central contact
12 key groove
13 pressing projection
14 mark
15 external retainer insertion groove
16 retainer insertion inlet
17 retainer
20 central contact
21 insulator
22 shell
23 internal retainer insertion groove

### CITATION LIST

Patent Literature 1: Japanese Patent Application Laid-Open No. 2018-098069
Patent Literature 2: Japanese Patent Application Laid-Open No. 2021-019116

1. An attachment structure of a connector, the connector comprising an internal fitting body and an external fitting body that are fitted to each other, so that a plug in either the internal fitting body or the external fitting body and a socket in the other are connected to each other in a manner that prevents detachment of the fixed connector in a fitting direction,
a key groove which extends in an axial direction of a cylinder on an inner circumferential surface, external retainer insertion grooves which are formed at an inner circumferential portion on both sides of the key groove with the key groove interposed therebetween, and a retainer insertion inlet which communicates with the external retainer insertion grooves are formed in the external fitting body,
the internal fitting body including a pressing projection which is provided to be protruded on an outer circumferential surface and is inserted into the key groove, and an internal retainer insertion groove which is formed at an outer circumferential portion on both sides of the pressing projection with the pressing projection interposed therebetween is formed in the internal fitting body, wherein
a retainer in which paired insertion pieces are supported on both ends of a retainer base portion is inserted from the retainer insertion inlet, the insertion pieces are inserted across the internal retainer insertion groove and the external retainer insertion grooves, and the retainer base portion is overlapped between edge portions on both sides of the pressing projection and on both sides of the key groove.

2. The attachment structure of a connector according to claim 1, wherein the pressing projection extends to an upper end of the internal fitting body.

3. The attachment structure of a connector according to claim 1, wherein the internal fitting body is provided to be protruded integrally with one surface of a box-shaped building frame.

4. The attachment structure of a connector according to claim 2, wherein the internal fitting body is provided to be protruded integrally with one surface of a box-shaped building frame.
